(19) United States
(12) Patent Application Publication
(10) Pub. No.: US 2026/0329643 A1
(43) Pub. Date: Oct. 22, 2026

(54) DECLARATIVE MODULAR ARTIFICIAL INTELLIGENCE ENGINE

(71) Applicant: eBay Inc., San Jose, CA (US)

(72) Inventors: Zhenhua TAN, Shanghai (CN); Guansheng ZHU, Shanghai (CN); Xin LI, Shanghai (CN); Zhengfei CHEN, Shanghai (CN); Vinay PHEGADE, Santa Clara, CA (US); Tianyu CHEN, Suzhou City (CN); Haowei TIAN, Shanghai (CN); Yiheng WANG, Shanghai (CN); Zhongyuan WU, Shanghai (CN)

(21) Appl. No.: 19/183,309

(22) Filed: Apr. 18, 2025

(51) Int. Cl. G06F 9/50

(52) U.S. Cl. CPC G06F 9/5027

(57) ABSTRACT

Methods, systems, and computer storage media for providing a declarative modular artificial intelligence (AI) engine in an artificial intelligence system are described. The declarative modular AI engine streamlines AI pipeline development by enabling users to create, manage, and deploy modular AI workflows with minimal coding. Declarative modular AI engine provides a drag-and-drop UI and a declarative programming interface, allowing users to assemble AI pipelines using reusable modules. A modular pipeline definition serves as a blueprint, defining execution logic and configurations. An AI template management engine categorizes and stores pipeline templates, ensuring efficient retrieval, versioning, and metadata tagging. A flow writer engine dynamically rewrites pipeline logic, enabling modules to transition between batch, near real-time (NRT), and real-time (RT) processing. An execution engine translates the pipeline into an optimized execution plan, deploys it, and validates execution. Declarative modular AI engine automates AI integration and output communication, ensuring seamless execution across different environments.

### BACKGROUND

Users leverage AI to automate tasks, enhance decision-making, and optimize processes by analyzing large amounts of data and providing insights or predictions. Artificial Intelligence (AI) has become a cornerstone across multiple industries, driving innovation in various domains. AI encompasses the design and implementation of computational models and algorithms that replicate cognitive processes, with the creation of these models typically structured within an AI pipeline. An AI pipeline is a systematic, iterative framework engineered to manage the end-to-end lifecycle of an AI system, from initial conception to final deployment. The pipeline includes several critical stages, such as data acquisition, preprocessing, model design, training, evaluation, and deployment. AI pipeline development supports the creation of diverse AI models, including batch processing models, near-real-time (NRT) models, and real-time models, each offering distinct advantages and constraints. Due to the complexity of AI model generation and the variety of model types, the development of AI pipelines often involves collaboration across various organizational levels.

### SUMMARY

Various aspects of the technology described herein are generally directed to systems, methods, and computer storage media for, among other things, providing a declarative modular artificial intelligence (AI) engine that supports streamlining the development, deployment, and management of AI pipelines through a high-level, declarative and modular approach. This declarative, modular Artificial Intelligence (AI) engine enables users to define AI workflows through reusable, modular components, facilitating platform-agnostic, flexible, and efficient pipeline construction. With the growing adoption of Language Learning Models (LLMs), there is an increasing demand for the development of optimized AI pipelines to support LLM applications. However, creating these pipelines can be complex, especially for teams with varying levels of expertise.

In operation, a modular pipeline definition is accessed. The modular pipeline definition comprises a reusable module associated with a first processing category and a task-specific processor script. The modular pipeline definition operates as a blueprint for constructing an artificial intelligence (AI) pipeline. One or more declarative modular artificial intelligence engine operations are executed to cause execution of the AI pipeline. The AI pipeline is executed based on the reusable module and the task-specific processor script, wherein the AI pipeline is executed using a second processing category. Based on executing the AI pipeline, an output associated with the AI pipeline is generated. The output is communicated.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1A illustrates an example high level architecture for a declarative modular AI platform, in accordance with aspects of the technology described herein.

FIG. 1B is a block diagram of an example implementation by a user generating a new AI solution pipeline utilizing the declarative modular AI platform, in accordance with aspects of the technology described herein;

FIG. 2A is a block diagram of an artificial intelligence system for generating declarative and modularized AI pipelines, in accordance with aspects of the technology described herein;

FIG. 2B is a flow diagram of an artificial intelligence system for generating declarative and modularized AI pipelines, in accordance with aspects of the technology described herein;

FIG. 3 provides a first exemplary method for generating AI solution pipelines utilizing a declarative modular AI platform, in accordance with aspects of the technology described herein;

FIG. 4 provides a second exemplary method for generating AI solution pipelines utilizing a declarative modular AI platform, in accordance with aspects of the technology described herein;

FIG. 5 provides an exemplary method for generating AI pipeline templates utilizing a declarative modular AI platform, in accordance with aspects of the technology described herein;

FIG. 6 provides a block diagram of an exemplary item listing system computing environment suitable for use in implementing aspects of the technology described herein;

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION

### Overview

An item listing system and platform support storing items (products or assets) in item databases and providing a search system for receiving queries and identifying search result items based on the queries. An item (e.g., physical item or digital item) refers to a product or asset that is provided for listing on an item listing platform. Search systems support identifying, for received queries, result items from item databases. Item databases can specifically be for content platform or item listing platforms such as EBAY content platform, developed by EBAY INC., of San Jose, California.

An item listing system may also provide generative-AI-supported applications (“generative AI applications”) that leverage generative AI models (e.g., Large Language Models—“LLM”) to create, generate, or produce content, data or outputs. LLMs are a specific class of generative AI models that are primarily focused on generating human-like text. Generative AI models, like GPT (Generative-Pre-trained Transformer) and its variants, are designed to generate human-like text or other types of data based on the input they receive (e.g., via a prompt interface). These applications use generative AI to perform various task across different domains to provide improvement in automation, efficiency, and human-like interaction.

These item listing systems collect extensive data on user behavior, demographics, interactions, and product-related information, often through cookies, pixels, or device identifiers. This large volume of data is then leveraged to enhance user experiences through AI solutions that process and analyze the data, providing insights into the purchasing and listing process. Various AI processing categories are used for data analysis, including batch processing, near-real-time (NRT) processing, and real-time processing. Batch processing aggregates data into groups and processes it at scheduled intervals, handling large volumes of data but without providing immediate results. NRT processing reduces latency by processing data with minimal delay, offering results more quickly than batch processing but not in real-time. Real-time processing analyzes data as it is generated or received, providing immediate feedback, often with latency measured in milliseconds or microseconds.

Given the high demand for solutions and the processing of vast amounts of data, AI solutions have become increasingly prevalent in item listing systems and platforms. AI solution development typically involves the creation of software pipelines. A software pipeline refers to the series of automated, interconnected tasks designed to manage the workflow of software development, ensuring consistency, efficiency, and reliability in creating AI solutions. The pipeline typically consists of several stages: the code development stage, where users write and update code in version control systems, often in collaboration across departments; the build stage, where code is compiled into executable artifacts using tools such as Maven, Gradle, or Docker; the testing stage, which involves running automated tests to ensure functionality, performance, and reliability; the integration stage, where code is merged into a central repository and integration tools ensure minimal issues; and finally, the deployment stage, where code is packaged for production using tools like Kubernetes, Docker, or AWS Code Pipelines. Monitoring tools are employed throughout the pipeline to ensure operational stability and detect potential issues.

Conventional AI pipelines are often rigid, platform-dependent, and resource-intensive, lacking the modularity, automation, and interoperability required for modern AI workflows. These pipelines demand substantial engineering effort, are slow to iterate, and struggle with transitioning from testing to production, particularly as large language models (LLMs) become central to advanced data applications. Organizations face significant challenges due to fragmented technology stacks, inefficient iteration processes, and resource-heavy transitions from prototype models to production systems, often involving disparate programming languages such as Python for research and Java for production. These inefficiencies lead to bottlenecks that can extend deployment cycles by over two months. Furthermore, the lack of standardized pipeline management results in duplicated efforts, draining resources and limiting the ability to experiment rapidly. To stay competitive, organizations require a robust, platform-agnostic approach that streamlines pipeline construction, promotes reusability, and accelerates iteration, enabling data science and engineering teams to focus on innovation rather than repetitive tasks

Conventional AI pipelines and machine learning (ML) solutions often suffer from fragmentation due to differing technical stacks between research and production environments, leading to complex engineering efforts to translate models and workflows. Designing AI solution pipelines is a time-intensive process that often requires advanced knowledge of multiple coding languages, typically involving input from various departments within an organization. To accelerate the design, testing, and implementation of AI solutions, there is a growing need for platforms that simplify pipeline creation, enabling faster deployment and participation from individuals with diverse technical backgrounds.

Moreover, the diversity of platforms used in pipeline development adds further complexity, resulting in significant variation between pipelines. Typically, AI pipelines include batch data processing pipelines, which may involve technologies such as Spark, GPU-based model inference, or vector database ingestion. AI pipelines may also incorporate Near-Real-Time (NRT) pipelines for event processing, where multiple services are orchestrated together. Additionally, real-time pipelines handle request processing, where various components work in concert to achieve a streamlined process. Each pipeline form varies significantly across different platforms. The process of building these pipelines is often time-consuming, as it requires collaboration from multiple organizational levels working in unison.

By way of example, consider a company developing an AI-driven recommendation system for an online store. The data scientists in the research team build a machine learning model in Python, using popular libraries like TensorFlow and Scikit-learn. However, when the model is ready to be deployed in production, the engineering team works with Java and a different tech stack designed for scalable, high-performance environments.

As a result, the research model needs to be completely re-engineered to fit the production environment, which involves translating the Python code into Java, adapting it to the company's data infrastructure, and ensuring that the model can handle real-time user interactions. This translation process is time-consuming, error-prone, and often leads to inconsistencies between what was tested in the research phase and what actually runs in production. In this scenario, the lack of a standardized, modular architecture leads to duplicated efforts and bottlenecks, as well as the constant back-and-forth between teams to ensure the model works seamlessly across environments. This process could take months to complete, slowing down the company's ability to innovate and deploy new AI-driven features quickly. As such, a more comprehensive AI pipeline engine—with an alternative basis for providing AI pipeline management functionality-can improve computing operations and interfaces for AI solutions.

### Description of Technical Solution

At a high level, a declarative modular artificial intelligence (AI) engine is provided to support streamlining the development, deployment, and management of AI pipelines through a high-level, declarative and modular approach. The declarative modular AI engine is a modularized machine learning (ML) solution pipeline that is designed to unify and streamline the development, deployment, and execution of machine learning (ML) solutions across multiple environments, including batch processing, near real-time (NRT), and real-time (RT) applications.

At the core of the declarative modular AI engine is the concept of modularization, which allows for the encapsulation of reusable logic and the seamless integration of different runtime providers. By breaking down ML solutions into discrete, reusable modules, the pipeline of the declarative modular AI engine optimizes workflow execution while abstracting deployment details, performance tuning, and integration complexities. This modular approach also provides enhanced tracking, lineage management, and visualization, enabling users to understand and refine their ML processes more efficiently.

The architecture of the declarative modular AI engine is built around multiple layers that collectively ensure coordinated pipeline orchestration. The interface layer offers two primary modes of interaction: a graphical drag-and-drop UI that enables a no-code experience for users to construct ML pipelines visually, and a Python SDK that allows developers to programmatically define, manage, and execute ML workflows. Underpinning the interface layer is the metadata and management layer, which stores and organizes pipeline definitions, execution metadata, and reusable components. This metadata-driven approach ensures version control, access management, and seamless updating of pipeline elements over time.

The execution layer handles the actual processing of ML tasks, relying on a standalone execution engine capable of interfacing with different runtime environments. It incorporates a flow rewriter, which dynamically translates high-level pipeline logic into optimized execution plans, adapting workflows for execution within engines such as Ray or Airflow. The runtime layer further enhances flexibility by supporting the execution of tasks across varied infrastructure setups, ensuring efficient deployment in different operational contexts.

The declarative modular AI engine operates based on a unified pipeline specification, which defines each ML workflow in terms of its flow logic, processor scripts, and metadata dependencies. Pipelines are represented as directed acyclic graphs (DAGs), ensuring a structured approach to task dependencies and execution order. Each task within a pipeline is instantiated as a module with defined parameters, allowing for easy modification and reuse. This specification provides a consistent framework for building ML solutions, whether they involve data ingestion, preprocessing, model inference, or post-processing steps.

The metadata management system underpins the solution by providing structured storage for module definitions, execution logs, and lineage tracking. It enables users to retrieve historical execution data, analyze dependencies between different pipeline components, and ensure proper versioning of ML models and processors. The metadata infrastructure also facilitates compliance and auditing by maintaining a clear record of how ML solutions evolve over time.

A key advantage of this modular approach is the ability to separate pipeline logic from execution details, allowing developers to focus on high-level ML workflows without concerning themselves with infrastructure complexities. The declarative modular AI engine includes an SDK that streamlines the integration of ML models and tasks, providing a seamless development experience. The framework supports local execution for rapid prototyping, ensuring that users can test and validate their workflows before deploying them at scale.

The pipeline rewriter supports adapting ML solutions to different execution environments. The pipeline rewriter automatically converts pipeline logic into the appropriate format for execution within a given runtime, ensuring optimal performance and resource utilization. For example, a batch processing workflow may be rewritten to leverage distributed execution within Ray, while an NRT solution may be optimized for event-driven execution. This adaptability allows organizations to maintain a single pipeline definition that can be deployed across multiple environments without requiring extensive reconfiguration.

The integration of continuous integration and continuous deployment (CI/CD) practices ensures that ML solutions can be developed, tested, and deployed in an automated manner. The pipeline rewriter supports automated pipeline deployments, allowing models and workflows to be continuously updated with minimal manual intervention. Additionally, it interfaces with external services such as model management systems, metadata stores, and deployment orchestrators to enable seamless execution and monitoring.

During runtime, the pipeline rewriter dynamically retrieves necessary model files and processors from a model management service, fetches metadata from the metadata store, and triggers execution within the designated runtime environment. This ensures that ML pipelines always operate with the latest available models and configurations, reducing the risk of outdated or inconsistent executions.

By unifying ML development across batch, NRT, and RT environments, the declarative modular AI engine provides a scalable and efficient framework for deploying machine learning solutions. The modular architecture of the declarative modular AI engine reduces engineering overhead, accelerates time-to-production, and enhances the maintainability of ML workflows. With a focus on user experience, the declarative modular AI engine empowers both data scientists and engineers to construct, modify, and deploy ML solutions with ease, ultimately driving greater efficiency and innovation in machine learning applications.

By way of example, a user interested in developing an AI-powered recommendation system for an item listing platform decides to create a machine learning pipeline using the declarative modular AI engine. Instead of building a pipeline from scratch, the user explores the declarative modular AI engine's metadata-organized store of pre-built pipeline templates and modular components. A search is conducted through the interface, where relevant task-specific processor scripts are located. A module designed for real-time cursor movement analysis is found, even though the user intends to develop a batch-based recommendation engine. Despite this discrepancy, the user selects the pre-built module and seamlessly integrates it into the new pipeline using the declarative modular AI engine's drag-and-drop functionality.

Upon placing the module into the pipeline, no manual modifications to the underlying code or architecture are required to transition the module from real-time processing to batch processing. Instead, the declarative modular AI engine's flow writer automatically rewrites the execution logic to accommodate batch-mode processing. The user then customizes the pre-built module to align with the AI solution's specific needs, ensuring that cursor movement data is aggregated over extended time periods rather than processed as live event streams. Other pre-made modules, such as item similarity analysis and collaborative filtering, are similarly incorporated, allowing the recommendation engine to infer user preferences from cursor-based interactions.

The unified pipeline specification ensures that data flows seamlessly between modules. A data enrichment module is employed to incorporate additional contextual signals, such as user demographics and past purchase history. A machine learning inference module retrieves pre-trained recommendation models from the model repository, and a ranking module refines the recommendations based on business-defined scoring mechanisms. The pipeline rewriter optimizes execution by converting the real-time modules into batch-compatible components without requiring user intervention.

Once the pipeline is configured, the declarative modular AI engine enables test runs using sample data, allowing the user to validate performance before full deployment. The deployment service automatically prepares the pipeline for execution, integrating it into the platform's batch processing environment. After deployment, the pipeline runs on scheduled intervals, processing large volumes of interaction data to generate personalized recommendations for users.

Through this modularized approach, the AI solution is built efficiently, leveraging pre-existing, reusable pipeline components while adapting them dynamically to the required processing framework. The ability to integrate and customize modules without manual coding reduces complexity and accelerates development. As a result, the AI-powered recommendation system is created without requiring specialized engineering knowledge or coordination with additional team members, demonstrating the declarative modular AI engine's ability to empower users with varying levels of expertise.

Advantageously, the declarative modular AI engine overcomes the limitations of conventional AI pipelines by introducing a declarative, modular framework that streamlines transitions between testing and production environments. The declarative modular AI engine provides reusable modules, an intuitive drag-and-drop interface, a flow rewriter engine, and centralized pipeline templates, enabling efficient design, execution, flexibility, and long-term maintenance of AI pipelines across diverse environments. Featuring integrated resource management, task orchestration, and access controls, the tool accelerates the deployment of end-to-end pipelines while offering enhanced flexibility, allowing teams to focus on maximizing the impact of their AI initiatives.

The declarative modular AI engine is designed to enable users of varying skill levels to generate, review, and test AI pipelines, regardless of the specific AI solution type. The declarative modular AI engine includes four primary components: the interface component, the AI template management engine, the flow writer engine, and the execution component. The interface component provides a user-friendly environment for interacting with the engine. The AI template management engine organizes AI modules using metadata and stores both modules and previously created pipelines as reusable templates. These templates can be leveraged to create new AI solutions. The declarative modular AI engine uses metadata and user-generated tags to categorize AI modules and pipelines, which can then be accessed by users to build their own custom AI pipelines. Users can interact with the interface to search for and select pre-built modules and pipelines, integrating them into their new AI solutions. These pre-made modules and pipelines can be used across different processing categories, meaning they are not limited to the same type as the new pipeline being created. The flow writer engine ensures that pre-existing modules are updated and compatible with the new processing category or platform, facilitating seamless integration. This structure empowers users, regardless of expertise, to create unique AI solution pipelines by mixing pre-built modules with new components, overcoming limitations related to processing categories.

### Example System and Resources

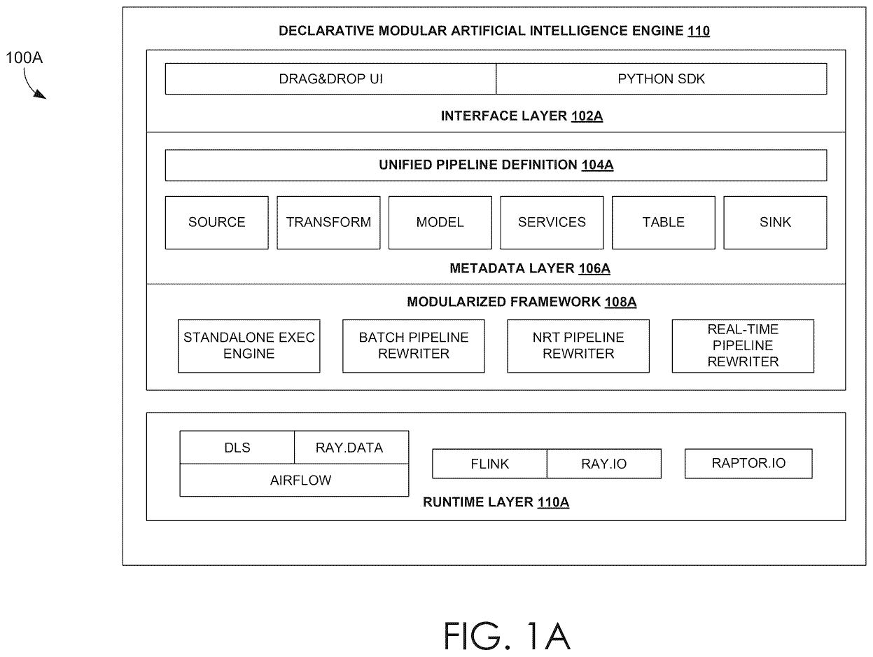

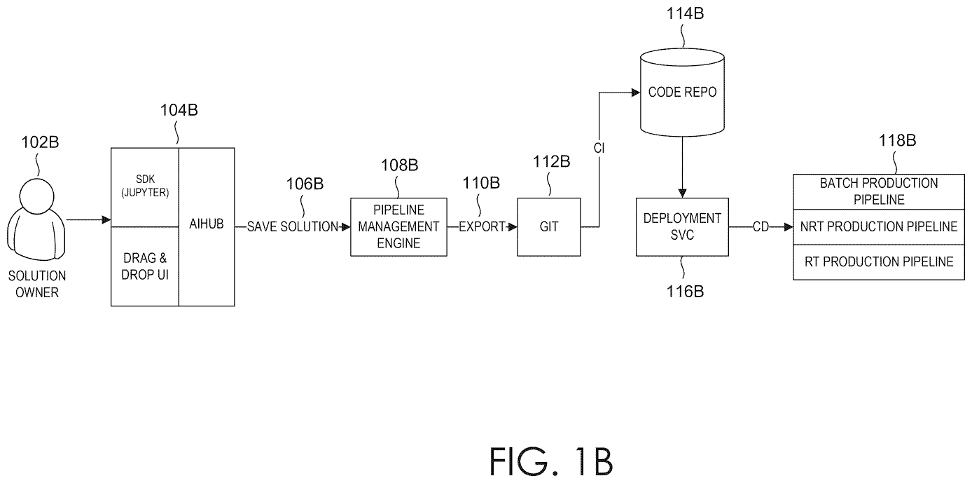

Aspects of the technical solution can be described by way of examples and with reference to FIG. 1A-1B. FIG. 1A illustrates an architecture of an Artificial Intelligence (AI) system 100A of a declarative modular artificial intelligence (AI) engine 110, designed to streamline AI pipeline development by modularizing components and enabling seamless execution across batch, near real-time (NRT), and real-time processing environments. In this exemplary illustration, the AI system 100A facilitates both low-code/no-code development through a drag-and-drop UI and programmatic control via a Python SDK, ensuring flexibility and efficiency in building and deploying AI solutions.

At its core, the declarative modular AI engine 110 features an interface layer 102A that allows users to interact with the pipeline through either a graphical drag-and-drop UI or a Python SDK. The drag-and-drop UI simplifies AI pipeline construction by enabling users to visually select and connect modular components, eliminating the need for manual coding. For more advanced users, the Python SDK provides a robust development toolkit with APIs for defining, modifying, and executing AI pipelines programmatically, offering a higher level of customization and control.

Serving as the foundation for pipeline execution, the unified pipeline definition 104A establishes a structured framework that dictates how different pipeline components interact. By maintaining a standardized orchestration process, it ensures that AI workflows can seamlessly operate across batch processing, near real-time (NRT), and real-time environments without requiring significant modifications. This structured orchestration allows AI developers to focus on optimizing their models and data flows rather than handling infrastructure complexities.

To support efficient pipeline management, the metadata layer 106A is responsible for storing and maintaining critical information related to pipeline configurations, execution history, and dependencies. This metadata tracking enables versioning, lineage tracing, and process auditing, ensuring that AI models and transformations remain transparent, reproducible, and easy to update. With a well-organized metadata system, users can retrieve previous versions of their pipelines, monitor changes over time, and maintain control over the evolution of their AI solutions.

At part of the execution process, the modularized framework 108A consists of several key components that govern the transformation and execution of AI workflows. The standalone execution engine functions as an independent runtime that can execute AI pipelines without relying on external orchestrators, providing a streamlined approach to deployment. To enhance workflow adaptability, the batch pipeline rewriter converts real-time or NRT modules into batch-compatible processes, enabling large-scale data processing at scheduled intervals. The NRT pipeline rewriter, on the other hand, transforms AI workflows for low-latency inference and processing, ensuring that AI models can operate efficiently in near real-time environments. Meanwhile, the real-time pipeline rewriter allows AI pipelines to be converted into event-driven processing models, facilitating immediate response to incoming data streams.

The runtime layer 110A integrates multiple execution engines, ensuring that AI workflows can be processed efficiently across diverse computing environments. Distributed Learning Systems (DLS) support large-scale machine learning model training and execution, while ray. data provides distributed data processing capabilities optimized for ML workloads. Airflow, a widely used orchestration tool, enables batch workflow management, ensuring that AI jobs are scheduled and executed systematically. For real-time processing, Flink is employed to handle high-throughput event-driven applications, allowing AI models to process and analyze data streams instantly. Additionally, ray. io supports parallel AI workload execution, enabling distributed model inference and task distribution. Raptor.io, a high-performance data processing engine, is also incorporated to facilitate rapid data ingestion and transformation, further enhancing the overall efficiency of AI pipelines.

By leveraging these components, the AI system 100A ensures that AI solutions are developed in a modular, scalable, and flexible manner. Developers can reuse pre-built pipeline components, transition seamlessly between different execution models without re-engineering workflows, and optimize processing based on specific computational requirements. This modular approach not only accelerates AI deployment but also enhances maintainability, making it easier to iterate on and refine AI solutions over time.

By way of example, creating an AI solution from the ground up is an incredibly complex and time-consuming task. Without any pre-built components or reusable code, a developer would need extensive education and experience just to begin the process. Constructing a pipeline for such a solution would require writing each piece of logic manually, line by line, ensuring that every component is correctly integrated and optimized. This process could take weeks or even months, not including the years of study needed to understand machine learning, data processing, and pipeline orchestration. Moreover, many AI solutions share common components—modules that handle data ingestion, transformation, model inference, and post-processing. While these components could theoretically be reused across multiple projects, without a structured platform to organize and integrate them, each new AI solution would require a developer to locate, extract, and refactor existing code or, in many cases, rewrite it from scratch.

Now, imagine a platform that eliminates these barriers—a system that is both user-friendly and accessible, enabling individuals at various levels of expertise to construct sophisticated AI pipelines without having to build them from the ground up. Such a platform is realized in the declarative modular AI engine, which provides a structured environment where AI solutions can be developed by leveraging pre-made pipeline components and dynamically adapting them to different processing needs. Instead of manually writing every aspect of an AI pipeline, users can search for existing modules that match their needs, incorporate them into their workflow, and customize them as required.

For instance, consider a user who wants to build an AI pipeline that reads cursor movements on an e-commerce website to determine optimal advertisement placements. Instead of starting from scratch, the platform allows the user to search for existing modules related to cursor tracking and interaction analysis. A previous pipeline, designed for a bidding system that analyzes cursor movements to assess buyer intent, may have stored its cursor tracking module with relevant metadata, making it discoverable in the platform's module repository. By identifying and selecting this module, the user can simply drag and drop it into their new pipeline. Once integrated, modifications can be made as necessary, either through a graphical user interface or programmatically using the Python SDK. This ability to reuse and customize pre-built pipeline elements significantly reduces the time and effort required to develop AI solutions.

Furthermore, the platform eliminates the need for users to manually adjust modules between different processing paradigms, such as batch, near real-time (NRT), or real-time execution. Traditionally, transitioning a module from real-time streaming to batch processing would require refactoring the underlying code and reconfiguring execution logic. However, within this modular AI engine, flow writers handle these transformations automatically. When a user selects a module designed for real-time processing but needs to use it in a batch pipeline, the declarative modular AI engine's batch pipeline rewriter dynamically converts it, ensuring that it fits the required workflow without requiring manual intervention. Similarly, an NRT pipeline can be adapted to run in a real-time execution mode through the real-time pipeline rewriter.

With reference to FIG. 1B, FIG. 1B illustrates a high-level workflow of how an AI pipeline is developed, managed, and deployed within a declarative modular AI engine. The declarative modular AI engine enables solution owners to create AI workflows using a low-code/no-code Drag & Drop UI or a Python SDK, ensuring both accessibility and customization. The designed pipelines are managed, versioned, and stored before being deployed to production through a Continuous Integration (CI) and Continuous Deployment (CD) process, ultimately supporting batch, near real-time (NRT), and real-time (RT) execution environments.

The process begins with the Solution Owner 102B, is responsible for designing and managing AI solutions. This individual interacts with the AI system through AIHub 104B, a development platform that includes both a Drag & Drop UI and an SDK (Jupyter Notebook integration). The UI allows non-technical users to build AI pipelines visually, while the SDK provides a programmatic interface for advanced users who prefer to define workflows using code. Once a pipeline is created or modified, the solution is saved (i.e., save solution 106B) within the pipeline management engine 108B ensuring that metadata, configurations, and pipeline structures are stored securely.

From there, the pipeline is exported 110B to a Git 112B repository, allowing version control and collaboration. This step ensures that AI workflows are tracked, with changes being logged and managed efficiently. As part of the CI process, the pipeline code is automatically integrated into the code repository 114B, where it undergoes validation, linting, and potential testing before being prepared for deployment.

Once the pipeline passes the necessary CI checks, the deployment services (SVC) 116B takes over, handling the transition from development to production. The deployment service ensures that the AI solution is correctly configured for execution across different processing paradigms. Through the CD process, the pipeline is deployed into one of one or more environments 118B: Batch Production Pipeline, NRT Production Pipeline, or RT Production Pipeline. The batch pipeline is optimized for large-scale, scheduled data processing, while the NRT pipeline supports low-latency inference and analysis. The RT pipeline is designed for immediate, event-driven execution, enabling AI solutions to respond to real-time data streams with minimal delay.

This workflow automates the lifecycle of AI pipelines, reducing the need for manual intervention while ensuring scalability, reproducibility, and efficiency. By leveraging modular pipeline management, version control through Git, and streamlined CI/CD deployment, the system enables users to build, test, and deploy AI solutions faster while maintaining flexibility across different execution environments.

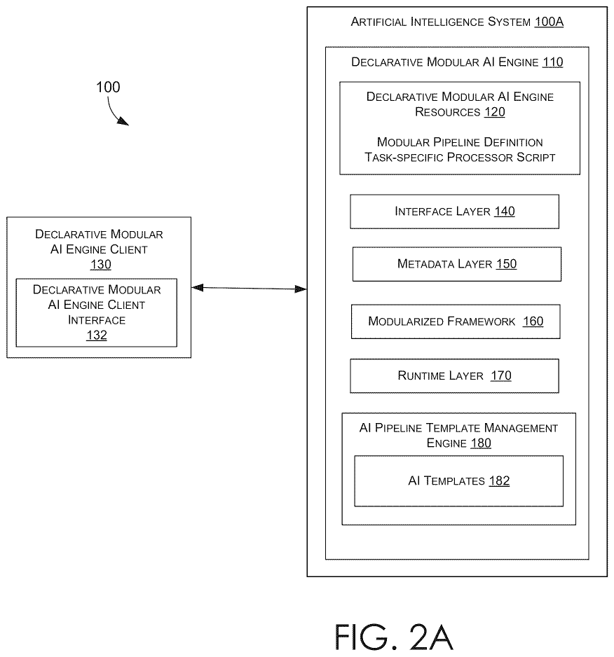

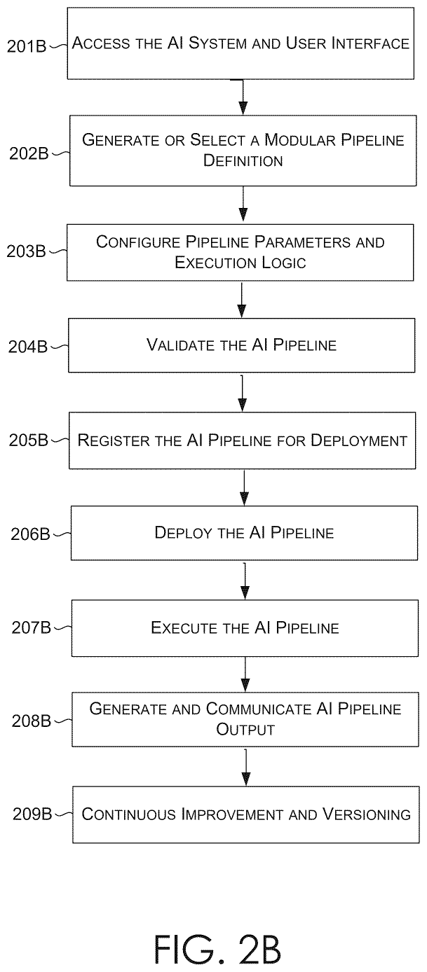

With reference to FIG. 2A, FIG. 2A illustrates cloud computing system 100 including artificial intelligence (AI) system 100A, declarative modular AI engine 110, declarative modular AI engine resources 120, declarative modular AI engine client 130, declarative modular AI engine client interface 132, interface layer 140, metadata layer 150, modularized framework 160, runtime layer 170, AI pipeline template management engine 180, and AI templates 182.

AI system 100A establishes a dynamic framework for providing a declarative modular AI engine 110 which designed to facilitate the creation, deployment, and management of AI pipelines. Artificial intelligence system 100A provides a structured framework that enables users to develop AI solutions using modular pipeline definitions, ensuring reusability, scalability, and adaptability across various AI applications. The declarative modular AI engine 110 serves as the primary interface through which users interact with the system, utilizing a declarative modular AI engine client 130 and declarative modular AI engine client interface 132 to define and execute AI pipelines. Within Artificial intelligence system 100A, several key components work together to streamline AI pipeline development, management, and execution.

The declarative modular AI engine 110 acts as the core processing unit, responsible for managing AI pipeline workflows. It includes declarative modular AI engine resources 120 which provide access to pre-built AI modules and processing scripts that define specific AI tasks. The modular pipeline definition serves as the blueprint for constructing AI pipelines, specifying the task execution order, dependencies, and logic that dictate how data flows through the pipeline. Declarative modular AI engine 110 further defines the execution logic within each module, ensuring that AI models process data efficiently and accurately.

The interface layer 140 provides the user-facing components necessary for interaction with the declarative modular AI engine 110. It allows users to define, modify, and execute AI pipelines through either a drag-and-drop UI or a declarative language interface. This layer abstracts complexity by simplifying the process of assembling AI workflows, enabling both technical and non-technical users to construct AI solutions.

The metadata layer 150 is responsible for storing and managing metadata associated with AI pipelines. This includes information about pipeline configurations, execution history, and version control, allowing users to track changes, maintain consistency, and retrieve historical pipeline versions when necessary. The metadata layer ensures that AI solutions remain well-documented, reproducible, and scalable.

The modularized framework 160 provides a structured environment in which AI pipelines operate. It includes mechanisms for modular component management, execution logic adaptation, and pipeline optimization. Modularized framework 160 ensures that AI modules can be reused across different pipelines and that processing logic is efficiently executed, minimizing resource consumption and maximizing performance.

The runtime layer 170 handles the execution of AI pipelines across different computing environments. It supports various processing categories, including batch processing, near real-time (NRT), and real-time execution, ensuring that AI models can be deployed in environments ranging from offline data processing systems to real-time decision-making applications.

The AI pipeline template management engine 180 serves as a repository for AI pipeline templates, facilitating the storage, categorization, and retrieval of reusable AI workflows. AI pipeline template management engine 180 supports pipeline versioning, metadata tagging, and access control, ensuring that users can efficiently find and repurpose existing AI solutions. AI templates 182 associated with the AI pipeline template management engine 180 act as pre-configured pipeline definitions that users can customize to fit their specific AI needs, significantly reducing development time and effort.

Together, these components enable a modular, scalable, and adaptive AI pipeline development framework, allowing users to rapidly build, test, and deploy AI solutions without requiring deep technical expertise. The Declarative Modular AI Engine ensures that AI development is efficient, standardized, and optimized for both innovation and operational performance.

For clarity and efficient reference, a glossary of key terms and concepts pertinent to the technical solution is provided below.
Modular Pipeline Definition: A structured blueprint for constructing an AI pipeline, consisting of reusable modules and task-specific processor scripts that define the pipeline's operational logic. It visually or programmatically represents the flow of execution, module dependencies, and processing logic, allowing AI solutions to be assembled using pre-built components.
Reusable Module: A self-contained functional unit within a modular pipeline definition, designed to be repurposed across various AI solutions. Each module is associated with a processing category (e.g., batch, NRT, or RT) and contains task-specific processor scripts that define its operation. Modules are managed by an AI template management engine to ensure their usability across multiple AI pipelines.
Processing Category: Defines how an AI pipeline executes data processing tasks. Categories include: Batch Processing: Processes large datasets at scheduled intervals, suitable for non-time-sensitive tasks. Near Real-Time (NRT) Processing: Processes incoming data with minimal delay, ideal for time-sensitive applications. Real-Time (RT) Processing: Processes and responds to data instantaneously, commonly used for event-driven solutions.
Flow Writer Engine: An engine that adapts and transforms AI pipeline logic between different processing categories, enabling a reusable module designed for one category (e.g., batch processing) to operate in another category (e.g., NRT or RT) without manual reconfiguration.
Execution Engine: Responsible for deploying a modular pipeline definition into an execution environment, optimizing its performance based on the required processing category. It handles both standalone environments for development and testing, and production environments for running AI pipelines at scale.
AI Pipeline Output and Communication: Involves generating output from AI pipeline computations and communicating that output to downstream systems or user interfaces. It can also produce a validation output to confirm successful execution or identify errors.
AI Pipeline Template: A stored, reusable representation of an AI pipeline that can be retrieved, modified, and deployed. Managed by the AI template management engine, it is categorized based on metadata for efficient search and reuse.
AI Template Management Engine: Manages AI pipeline templates and reusable modules, providing features like metadata tagging, version control, and processing category assignment. It ensures efficient storage, retrieval, and categorization of AI solutions.
User Interface (UI) and AI Pipeline Generation: Users interact with the system via a drag-and-drop UI or declarative language UI. The drag-and-drop UI enables visual construction of AI pipelines, while the declarative language UI allows programmatic pipeline definitions for experienced users.
AI Pipeline Management Data: Consists of configuration metadata, operational metadata, and documentation metadata to ensure AI pipelines are well-documented, versioned, and reproducible across deployments.
Flow Logic and Execution Plan: Defines the sequence and dependencies of tasks within a modular pipeline definition. The execution plan is derived from the flow logic and optimized for deployment, ensuring compatibility across different environments.
AI Pipeline Registration and Storage: New AI pipelines and reusable modules must be registered with the AI template management engine, which tracks pipeline configurations, execution metadata, and version history to ensure they are maintainable and scalable.
Declarative Modular AI Engine: The core framework that manages AI pipeline creation, adaptation, and execution. It enables users to define AI workflows declaratively, specifying desired outcomes rather than procedural steps, ensuring easy reusability and adaptability of AI pipelines.
Unified Pipeline Specification: Defines the structure and behavior of an AI pipeline, consisting of flow logic, processor scripts, and metadata. It ensures that AI pipelines are platform-agnostic and can be executed in various environments without major modifications.
Task-Specific Processor Script: A script defining the computational logic of a specific task within an AI module, such as data preprocessing, feature extraction, or model inference. These scripts can be customized based on execution needs.
Flow Rewriter: An intelligent component of the flow writer engine that dynamically rewrites pipeline logic to adapt modules for different processing environments, ensuring compatibility without manual changes.
Execution Environment: The computing infrastructure where AI pipelines run, which can include standalone environments for local development and testing, or production environments for scaling AI solutions in real-world applications.
AI Pipeline Validation: A process that ensures an AI pipeline's components function correctly before execution. It provides feedback on successful execution or identifies errors for correction before deployment.
AI Pipeline Communication: The step where output generated from an AI pipeline is communicated to external systems or user interfaces, ensuring seamless integration with broader workflows.
AI Pipeline Template Retrieval and Updating: Users can retrieve and modify AI pipeline templates from the AI template management engine, updating configurations or extending pipelines with additional reusable modules.
Modular Pipeline Dependencies and Execution Order: Defines the dependencies between tasks in a modular pipeline, ensuring proper execution order, data flow between modules, and parallelization for performance optimization.
AI Pipeline Registration: The process of registering new AI pipelines and reusable modules in the AI template management engine to ensure efficient reuse, version control, and scalability.
Reusable Module Management: Tracks, tests, and publishes reusable modules, ensuring they are defined, tested across various AI solutions, and available for broader use within the system.
AI Pipeline Request Handling: Users can request predefined AI pipeline templates from the AI template management engine, which provides easy access, metadata-driven search, and customization options to accelerate deployment.
Configuration Metadata, Operational Metadata, and Documentation Metadata: AI pipeline metadata includes configuration metadata (pipeline settings and dependencies), operational metadata (execution history and performance metrics), and documentation metadata (descriptive information for usability and maintenance), enhancing traceability and ease of maintenance.
AI Engine Client Interactions: The system supports various client interactions, including administrators managing templates and enforcing policies, developers customizing pipelines through SDKs and UIs, and end users assembling pipelines with minimal technical expertise. These interactions ensure accessibility across skill levels.

With reference to FIG. 2B, FIG. 2B, illustrates a schematic associated with providing a declarative modular AI engine in accordance with embodiments described herein. The technical solution of the declarative modular AI engine can be explained by way of steps and an example advertising campaign.
Step 201B: Access the AI System and User Interface. To begin working with the declarative modular AI engine, the user gains access through one of two interfaces. The Drag-and-Drop UI provides a visual, intuitive method for assembling AI pipelines, allowing users to construct workflows by simply selecting and connecting modular components. For those preferring a programmatic approach, the Declarative Language UI offers an SDK-based environment where AI pipelines can be defined and modified through code. Once inside the system, the Pipeline Builder Interface loads, presenting the user with a workspace where they can either create a new pipeline or modify an existing one.
Step 202B: Generating or Selecting a Modular Pipeline Definition. With access to the AI system, the user decides whether to start with a pre-existing AI pipeline template or to build a new pipeline from scratch. The AI template management engine provides a repository of reusable pipeline definitions, allowing users to select templates that align with their objectives. If no suitable template is found, the user constructs a new modular pipeline definition, either by dragging and dropping pre-built modules into a pipeline canvas or by configuring each pipeline task manually through the declarative language UI. The pipeline is structured using reusable modules, which represent predefined AI components, along with task-specific processor scripts that define the operational logic. Additionally, the user can determine the processing category, selecting whether the pipeline will function as a batch, near real-time (NRT), or real-time (RT) solution, depending on the speed and nature of execution required.
Step 203B: Configuring Pipeline Parameters and Execution Logic. Once the modular pipeline definition is established, the user fine-tunes the execution parameters to align with the intended functionality. The task execution order is specified, ensuring that dependencies between modules are appropriately managed and that tasks are processed in the correct sequence. Parameter settings for each module are customized to refine performance and adaptability. If a module originally designed for batch processing needs to function in real-time or NRT, the flow writer engine intervenes, rewriting pipeline logic to ensure compatibility without requiring manual adjustments. This seamless adaptation capability allows for maximum flexibility across different AI applications.
Step 204B: Validating the AI Pipeline. Before execution, the AI pipeline undergoes a pre-execution validation process to identify potential issues. Dependency checks confirm that all modules are correctly linked and able to interact without conflicts. The flow writer engine ensures that any necessary processing category adaptations have been correctly applied. Additionally, each task-specific processor script is reviewed to detect any syntax errors or misconfigurations that could hinder execution. The execution engine performs a test run, generating a validation output that informs the user whether the pipeline is ready for execution or if modifications are needed before proceeding.
Step 205B: Registering the AI Pipeline for Deployment. Once validated, the AI pipeline is registered within the AI template management engine, which organizes and stores it for future use. As part of this process, the system generates AI pipeline management data, which includes configuration metadata to store execution settings, operational metadata that tracks historical performance, and documentation metadata to guide future modifications. At this stage, the pipeline can either be stored as a reusable template for later retrieval or deployed immediately for execution.
Step 206B: Deploying the AI Pipeline. The user selects the execution environment, determining whether the pipeline will run in a standalone environment—used primarily for development and testing—or within a production environment, where it operates at scale as part of a deployed system. Upon deployment, the Execution Engine activates the pipeline, and if necessary, the flow writer engine automatically adapts the pipeline logic to ensure that it functions optimally within the selected environment.
Step 207B: Executing the AI Pipeline. Once deployed, the AI pipeline begins processing incoming data according to the predefined workflow. Each module executes its designated task, either sequentially or in parallel, based on the dependencies established during configuration. The AI Template Management Engine continuously monitors execution performance, logging results and tracking any deviations from expected behavior to ensure that the pipeline runs efficiently.
Step 208B: Generating and Communicating AI Pipeline Output. As execution completes, the AI pipeline produces an output derived from the processed data. This output may be stored in a database for further analysis, transmitted to external systems for real-time decision-making, or displayed within the user interface for human review and validation. If errors arise during execution, the execution engine provides diagnostic feedback, helping the user identify issues and make necessary adjustments to optimize performance.
Step 209B: Continuous Improvement and Versioning. Even after deployment, the AI pipeline remains adaptable, allowing for continuous improvement and versioning. Over time, users can refine the pipeline by updating reusable modules, modifying task-specific processor scripts, or adjusting execution logic based on real-world performance metrics. Versions of the pipeline are tracked within the ai template management engine, ensuring that previous iterations remain accessible for reference or rollback if needed. By maintaining a structured version control system, the AI engine enables long-term scalability and iterative development, ensuring that AI solutions remain efficient, flexible, and up to date.

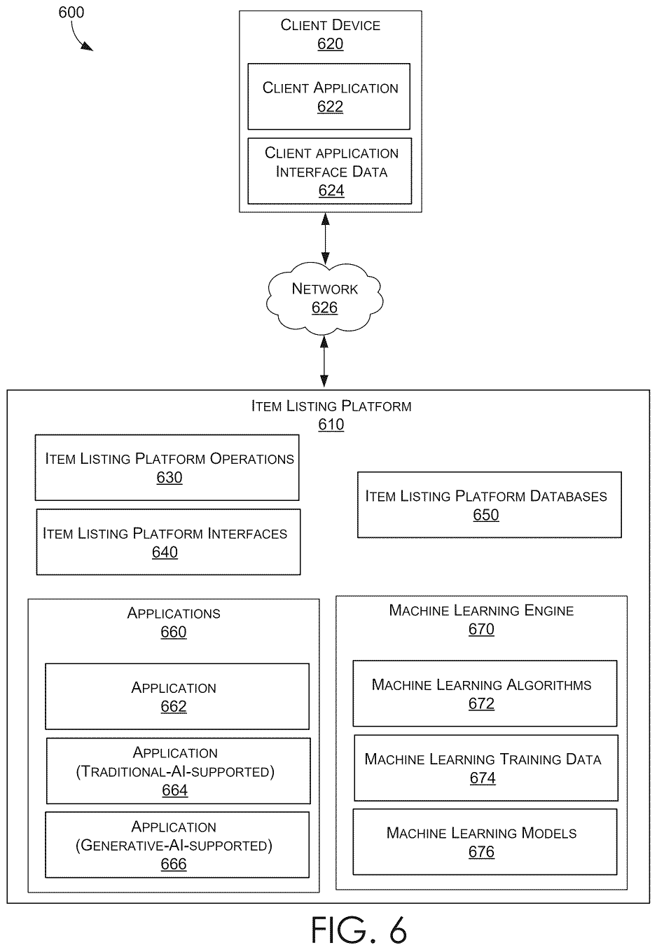

Aspects of the technical solution can be described by way of examples and with reference to FIGS. 1A, 1B, 2A, and 2B. FIG. 2A is a block diagram of an exemplary technical solution environment, based on example environments described with reference to FIGS. 6, 7, and 8 for use in implementing embodiments of the technical solution are shown. Generally, the technical solution environment includes a technical solution system suitable for providing the example item listing system 600 in which methods of the present disclosure may be employed. In particular, FIG. 2A shows a high-level architecture of the item listing system 100 in accordance with implementations of the present disclosure. Among other engines, managers, generators, selectors, or components not shown (collectively referred to herein as “components”), the item list system 100 of FIG. 2A support functionality described in FIGS. 1A and 1B.

### Example Methods

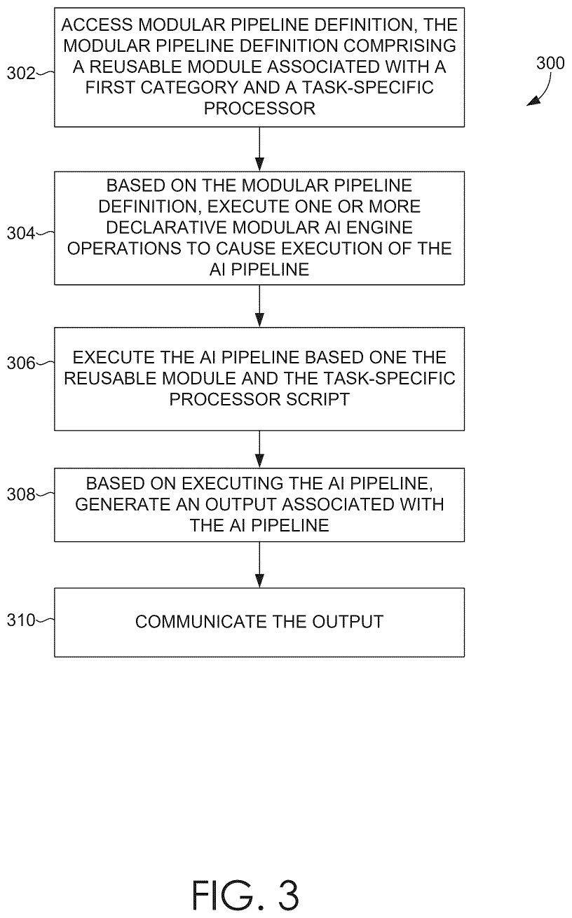

With reference to FIGS. 3, 4, and 5 flow diagrams that illustrate methods for providing a declarative modular AI engine in an artificial intelligence system. The methods may be performed using the artificial intelligence system described herein. In embodiments, one or more computer-storage media having computer-executable or computer-useable instructions embodied thereon that, when executed, by one or more processors can cause the one or more processors to perform the methods (e.g., computer-implemented method) in an artificial intelligence system (e.g., computerized system or computer system).

Turning to FIG. 3, a flow diagram is provided that illustrates a method 300 for providing a declarative modular AI engine in an artificial intelligence system. At block 302, access a modular pipeline definition, the modular pipeline definition comprising a reusable module associated with a first processing category and a task-specific processor script. The modular pipeline definition operates as a blueprint for constructing an artificial intelligence (AI) pipeline. At block 304, based on the modular pipeline definition, executing one or more declarative modular artificial intelligence engine operations to cause execution of the AI pipeline. At block 306, execute the AI pipeline based on the reusable module and the task-specific processor script. The AI pipeline is executed using a second processing category. At block 306, based on executing the AI pipeline, generating an output associated with the AI pipeline. At block 308, communicate the output.

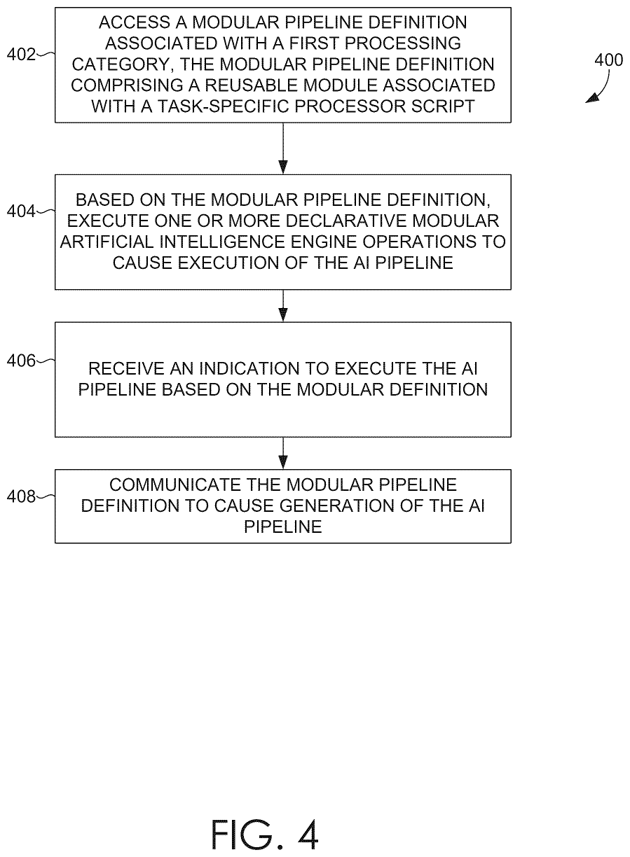

Turning to FIG. 4, a flow diagram is provided that illustrates a method 400 for providing a declarative modular AI engine in an artificial intelligence system. At block 402, access user input via a user interface (UI). The user input comprises a reusable module associated with a task-specific processor script. At block 404, based on the user input, generating a modular pipeline definition. The modular pipeline definition comprises a reusable module associated with a first processing category and a task-specific processor script. The modular pipeline definition operates as a blueprint for constructing an artificial intelligence (AI) pipeline and is associated with a declarative modular AI engine. At block 406, receive an indication to execute the AI pipeline based on the modular pipeline definition. At block 408, communicate the modular pipeline definition to cause generation of the AI pipeline, wherein the AI pipeline is generated using a second processing category.

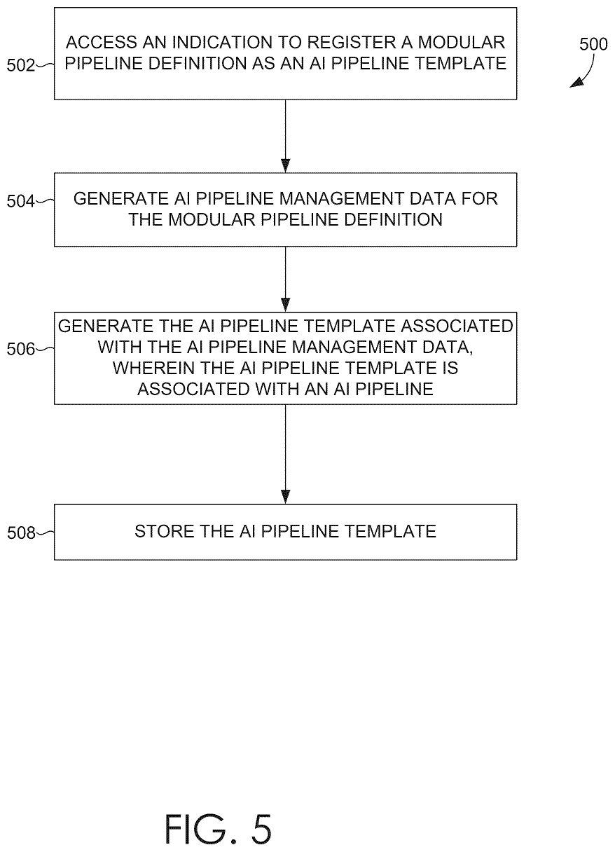

Turning to FIG. 5, a flow diagram is provided that illustrates a method 500 for providing a declarative modular AI engine in an artificial intelligence system. At block 502, access an indication to register a modular pipeline definition as an AI pipeline template. At block 504, generate AI pipeline management data for the modular pipeline definition. At block 506, generate the AI pipeline template associated with the AI pipeline management data. The AI pipeline template is associated with an AI pipeline template management engine that provides a repository and AI pipeline template management of the AI template. At block 508, store the AI pipeline template.

### Technical Improvement

Embodiments of the present invention have been described with reference to several inventive features (e.g., operations, systems, engines, and components) associated with an item listing system. Inventive features described include: operations, interfaces, data structures, and arrangements of computing resources associated with providing the functionality described herein relative with reference to a declarative modular AI engine associated with an artificial intelligence system.

Embodiments of the present invention relate to the field of computing, and more particularly to an artificial intelligence system. The following described exemplary embodiments provide a system, method, and program product to, among other things, execute generative AI system operations that provide a declarative modular AI engine. Therefore, the present embodiments improve the technical field of artificial intelligence technology and item listing platform technology enhancing the efficiency and effectiveness of developing AI pipelines. For example, declarative modular AI engine supports streamlining AI pipeline development, enhancing adaptability, and improving real-time decision-making. One key operation is modular pipeline definition and reusability, which enables AI components to be stored, categorized, and repurposed without rebuilding entire pipelines. This reduces development time, ensures standardization across AI solutions, and allows for scalable applications in e-commerce, such as product recommendations and fraud detection. Another essential operation is the flow writer engine, which dynamically rewrites pipeline logic to transition AI models between processing categories like batch, near real-time (NRT), and real-time execution. This ensures cross-category compatibility, optimizes resource allocation, and allows item listing platforms to deploy AI solutions that adapt to changing market conditions.

Finally, the execution engine and automated deployment streamline the transition from development to production, allowing AI pipelines to be tested, monitored, and refined in real-time environments. This enhances operational efficiency, ensures AI-driven decision-making can adjust dynamically to user interactions, and provides continuous performance tracking to improve accuracy in search rankings, pricing, and recommendations. By automating these processes, the system enables faster, smarter, and more efficient AI applications for e-commerce and beyond. a significant advancement in both artificial intelligence and item listing platform technologies.

Functionality of the embodiments of the present invention have further been described, by way of an implementation and anecdotal examples-to demonstrate that the operations for providing declarative modular AI management using a declarative modular AI engine in an artificial intelligence system as a solution to a specific problem in artificial intelligence technology to improve computing operations in artificial intelligence systems. Overall, these improvements result in less CPU computation, smaller memory requirements, and increased flexibility in artificial intelligence systems when compared to previous conventional artificial intelligence system operations performed for similar functionality.

### Additional Support for Detailed Description of the Invention

### Example Item Listing System Environment

Referring now to FIG. 6, FIG. 6 illustrates an example item listing system 600 computing environment in which implementations of the present disclosure may be employed. In particular, FIG. 6 shows a high-level architecture of an example item listing platform 610 that can host a technical solution environment, or a portion thereof. It should be understood that this and other arrangements described herein are set forth as examples. For example, as described above, many elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The item listing system 600 can be a cloud computing environment that provides computing resources for functionality associated with the item listing platform 610. For example, the item listing system 600 supports delivery of computing components and services-including servers, storage, databases, networking, applications, and machine learning associated with the item listing platform 610 and client device 620. A plurality of client devices (e.g., client device 620) include hardware or software that access resources on the item listing system 600. Client device 620 can include an application (e.g., client application 622) and interface data (e.g., client application interface data 624) that support client-side functionality associated with the item listing system. The plurality of client devices can access computing components of the item listing system 600 via a network (e.g., network 626) to perform computing operations.

The item listing platform 610 is responsible for providing a computing environment or architecture that includes the infrastructure that supports providing item listing platform functionality (e.g., e-commerce functionality). The item listing platform 610 support storing item in item databases and providing a search system for receiving queries and identifying search results based on the queries. The item listing platform 610 may also provide a computing environment with features for managing, selling, buying, and recommending different types of items. The item listing platform 610 can specifically be for a content platform such as EBAY content platform or e-commerce platform, developed by EBAY INC., of San Jose, California.

The item listing platform 610 can provide item listing operations 630 and item listing interfaces 640. The item listing operations 630 can include service operations, communication operations, resource management operations, security operations, and fault tolerance operations that support specific tasks or functions in the item listing platform 610. The item listing interfaces 640 can include service interfaces, communication interfaces, resource interfaces, security interfaces, and management and monitoring interfaces that support functionality between the item listing platform components. The item listing operations 630 and item listing interfaces 640 can enable communication, coordination and seamless functioning of the item listing system 600.

By way of example, functionality associated with item listing platform 610 can include shopping operations (e.g., product search and browsing, product selection and shopping cart, checkout and payment, and order tracking); user account operations (e.g., user registration and authentication, and user profiles); seller and product management operations (e.g., seller registration and product listing and inventory management); payment and financial operations (e.g., payment processing, refunds and returns); order fulfillment operations (e.g., order processing and fulfillment and inventory management); customer support and communication interfaces (e.g., customer support chat/email and notifications); security and privacy interfaces (e.g., authentication and authorization, payment security); recommendation and personalization interfaces (e.g., product recommendations and customer reviews and ratings); analytics and report interfaces (e.g., sales and inventory reports, and user behavior analytics); and APIs and Integration Interfaces (e.g., APIs for Third-Party Integration).

The item listing platform 610 can provide item listing platform databases (e.g., item listing platform databases 650) to manage and store different types of data efficiently. The item listing platform databases 650 can include relational databases, NoSQL databases, search databases, cache databases, content management systems, analytics databases, payment gateway database, customer relationship management databases, log and error databases, inventory and supply chain databases, and multi-channel databases that are used in combination to efficiently manage data and provide e-commerce experience for users.

The item listing platform 610 supports applications (e.g., applications 660) that is a computer program or software component or service that serves a specific function or set of functions to fulfil a particular item listing platform requirement or user requirement. Applications can be client-side (user-facing) and server-side (backend). Applications can also include application without any AI support (e.g., application 662) application supported by traditional AI model (e.g., application 664), and applications supported by generative AI models (e.g., application 666). By way of example, applications can include an online storefront application, mobile shopping app, admin and management console, payment gateway integration, user account and authentication application, search and recommendation engines, inventory and stock management application, order processing and fulfillment application, customer support and communication tools, content management system, analytics and report applications, marketing and promotion applications, multi-channel integration applications, log and error tracking applications, customer relationship management (CRM) applications, security applications, and APIs and web services that are used in combination to efficiently deliver e-commerce experiences for users.

The items listing platform 610 can include a machine learning engine (e.g., machine learning engine 670). The machine learning engine 670 refers to machine learning framework or machine learning platform that provides the infrastructure and tools to design, train, evaluate, and deploy machine learning models. The machine learning engine 670 can serve as the backbone for developing and deploying machine learning applications and solutions. Machine learning engine 670 can also provide tools for visualizing data and model results, as well as interpreting model decisions to gain insights into how the model is making predictions.

The machine learning engine 670 can provide the necessary libraries, algorithms, and utilities to perform various tasks within the machine learning workflow. The machine learning workflow can include data processing, model selection, model training, model evaluation, hyperparameter tuning, scalability, model deployment, inference, integration, customization, data visualization. Machine learning engine 670 can include pre-trained models for various tasks, simplifying the development process. In this way, the machine learning engine 670 can streamline the entire machine learning process, from data preparation and model training to deployment and inference, making it accessible and efficient for different types of users (e.g., customers, data scientists, machine learning engineers, and developers) working on a wide range of machine learning applications.

Machine learning engine 670 can be implemented in the item listing system 600 as a component that leverages machine learning algorithms and techniques (e.g., machine learning algorithms 672) to enhance various aspects of the item listing declarative modular AI engine's functionality. Machine learning engine 670 can provide a selection of machine learning algorithms and techniques used to teach computers to learn from data and make predictions or decisions without being explicitly programmed. These techniques are widely used in various applications across different industries, and can include the following examples: supervised learning (e.g., linear regression: classification, support vector machines (SVM); unsupervised learning (e.g., clustering, principal component analysis (PCA), association rules (e.g., apriori); reinforcement learning (e.g., Q-Learning, deep Q-Network (DQN); and deep learning (e.g., neural networks, convolutional neural networks (CNN), and recurrent neural networks (RNN); and ensemble learning random forest.

Machine learning training data 674 supports the process of building, training, and fine-tuning machine learning models. Machine learning training data 674 consists of a labeled dataset that is used to teach a machine learning model to recognize patterns, make predictions, or perform specific tasks. Training data typically comprises two main components: input feature (X) and labels or target values (Y). Input features can include variables, attributes, or characteristics used as input to the machine learning model. Input features (X) can be numeric, categorical, or even textual, depending on the nature of the problem. For example, in a model for predicting house prices, input features might include the number of bedrooms, square footage, neighborhood, and so on. Labels or target values (Y) include the values that the model aims to predict or classify. Labels represent the desired output or the ground truth for each corresponding set of input features. For instance, in a spam email classifier, the labels would indicate whether each email is spam or not (i.e., binary classification). The training process involves presenting the model with the training data, and the model learns to make predictions or decisions by identifying patterns and relationships between the input features (X) and the target values (Y). A machine learning algorithm adjusts its internal parameters during training in order to minimize the difference between its predictions and the actual labels in the training data. Machine learning engine 670 can use historical and real-time data to train models and make predictions, continually improving performance and user experience.

Machine learning engine 670 can include machine learning models (e.g., machine learning models 676) generated using the machine learning engine workflow. Machine learning models 676 can include generative AI models and traditional AI models that can both be employed in the item listing system 600. Generative AI models are designed to generate new data, often in the form of text, images, or other media, based on patterns and knowledge learned from existing data. Generative AI models can be employed in various ways including content generation, product image generation, personalized product recommendations, natural language chatbots, and content summarization. Traditional AI models encompass a wide range of algorithms and techniques and can be employed in various ways including recommendation systems, predictive analytics, search algorithms, fraud detection, customer segmentation, image classification, Natural Language Processing (NLP) and A/B testing and optimization. In many cases, a combination of both generative and traditional AI models can be employed to provide a well-rounded and effective e-commerce experience, combining data-driven insights and creativity.

Machine learning engine 670 can be used to analyze data, make predictions, and automate processes to provide a more personalized and efficient shopping experience for users. By way of example, product recommendations search and filtering: pricing optimization, inventory and stock management: customer segmentation, churn prediction and retention, fraud detection, sentiment analysis, customer support and chatbots, image and video analysis, and ad targeting and marketing. The specific applications of machine learning within the item listing platform 610 can vary depending on the specific goals, available data, and resources.

### Example Distributed Computing System Environment

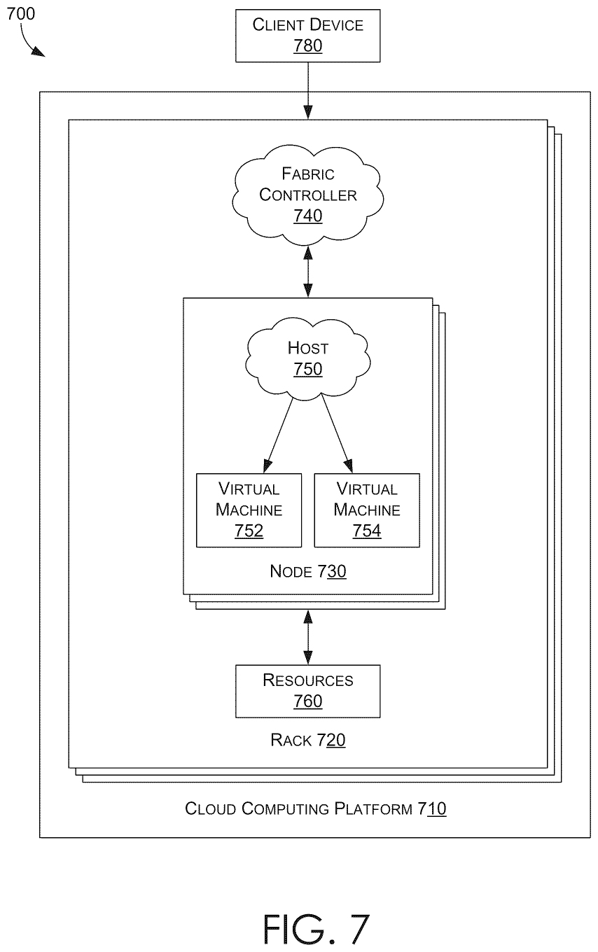

Referring now to FIG. 7, FIG. 7 illustrates an example distributed computing environment 700 in which implementations of the present disclosure may be employed. In particular, FIG. 7 shows a high-level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing platform 710 in a data center can be configured to host and support operation of endpoints of a particular service application. Cloud computing platform 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 800 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

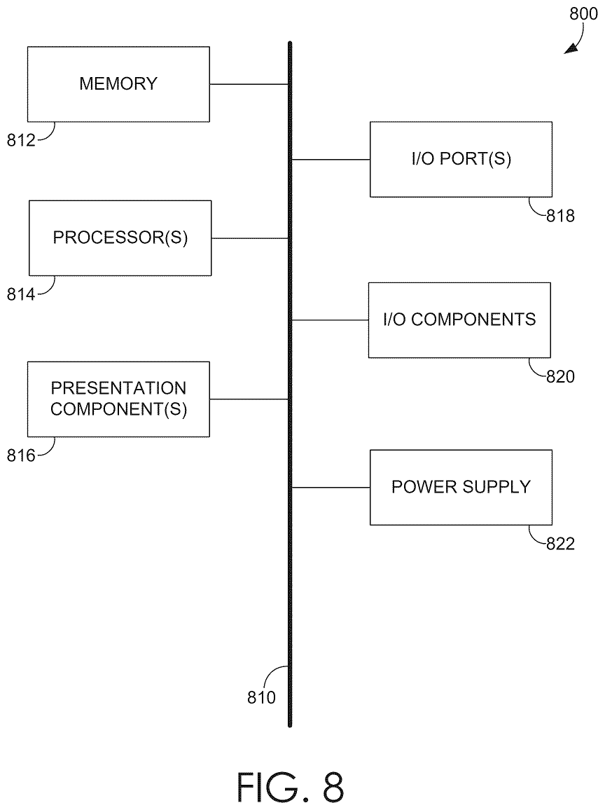

Having briefly described an overview of embodiments of the present invention, an example operating environment in which embodiments of the present invention may be implemented is described below in order to provide a general context for various aspects of the present invention. Referring initially to FIG. 8 in particular, an example operating environment for implementing embodiments of the present invention is shown and designated generally as computing device 800. Computing device 800 is but one example of a suitable computing environment and is not intended to suggest any limitation as to the scope of use or functionality of the invention. Neither should the computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art and reiterate that the diagram of FIG. 8 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however, the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious, and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing a modular pipeline definition, the modular pipeline definition comprising a reusable module associated with a first processing category and a task-specific processor script, wherein the modular pipeline definition operates as a blueprint for constructing an artificial intelligence (AI) pipeline;
based on the modular pipeline definition, executing one or more declarative modular artificial intelligence engine operations to cause execution of the AI pipeline;
executing the AI pipeline based on the reusable module and the task-specific processor script, wherein the AI pipeline is executed using a second processing category;
based on executing the AI pipeline, generating an output associated with the AI pipeline; and
communicating the output.

2. The system of claim 1, wherein the modular pipeline definition is a pipeline canvas representation of an AI pipeline in development, the modular pipeline definition representing reusable modules connected as a flow containing module processor logic associated with task-specific processor scripts.

3. The system of claim 1, wherein the reusable module is one of a plurality of reusable modules associated with a template management engine that provides a repository and management of the plurality of reusable modules, the template management engine supports module registration, versioning, testing, and publishing.

4. The system of claim 1, wherein the modular pipeline definition is associated with task configuration, parameter setting, execution order management associated with a sequence and dependencies of tasks to be executed, the modular pipeline definition identifies a processing category from a plurality of processing categories including: real-time data processing, near-real-time data process, or batch processing.

5. The system of claim 1, wherein executing the one or more declarative modular artificial intelligence engine operations includes:
translating the modular pipeline definition into an execution plan, wherein translating the modular pipeline definition is associated with a flow writer that rewrites a pipeline logic of the modular pipeline definition to adapt the modular pipeline definition from the first processing category to the second processing category.

6. The system of claim 1, wherein executing the AI pipeline comprises deploying the AI pipeline in a selected execution environment, wherein the AI pipeline is executable in a standalone environment or in a production environment.

7. The system of claim 1, wherein the modular pipeline definition is associated a declarative modular AI engine that operates based on a unified pipeline specification comprising a flow logic, processor scripts, and metadata.

8. A computer-implemented method, the computer-implemented method comprising:
accessing user input via a user interface (UI), wherein the user input comprises a reusable module associated with a task-specific processor script;
based on the user input, generating a modular pipeline definition, wherein the modular pipeline definition comprises the reusable module associated with a first processing category and the task-specific processor script, wherein the modular pipeline definition operates as a blueprint for constructing an artificial intelligence (AI) pipeline, and is associated with a declarative modular AI engine;
receiving an indication to execute the AI pipeline based on the modular pipeline definition; and
communicating the modular pipeline definition to cause generation of the AI pipeline, wherein the AI pipeline is generated using a second processing category.

9. The computer-implemented method of claim 8, wherein the UI is associated with a drag-and-drop UI and a declarative language UI, the drag-and-drop UI supports visual interactions with the modular pipeline definition and the declarative language UI supports programmatic interactions with the modular pipeline definition.

10. The computer-implemented method of claim 8, wherein the user input identifies an AI pipeline template, wherein the AI pipeline template is associated with a previous modular pipeline definition, wherein the user input further updates the AI pipeline template.

11. The computer-implemented method of claim 10, wherein processing categories include: real-time data processing, near-real-time data process, or batch processing, wherein a flow rewriter that rewrites a pipeline logic of the modular pipeline definition to adapt to different execution engine providers.

12. The computer-implemented method of claim 8, wherein the reusable module or task-specific processor scripts are associated with parameters associated with functional operations of the reusable module.

13. The computer-implemented method of claim 8, wherein communicating the modular pipeline definition to cause the generation of the AI pipeline causes execution of the AI pipeline to generate one or more results.

14. The computer-implemented method of claim 8, based on communicating the modular pipeline definition to cause the generation the AI pipeline, receiving a validation output associated with generating the AI pipeline, wherein the validation output indicates no errors with the AI pipeline or indicates one or more errors with the AI pipeline.

15. One or more computer-storage media having computer-executable instructions embodied thereon that, when executed by a computing system having a processor and memory, cause the processor to perform operations, the operations comprising:
accessing an indication to register a modular pipeline definition as an AI pipeline template;
generating AI pipeline management data for the modular pipeline definition;
generating the AI pipeline template associated with the AI pipeline management data, wherein the AI pipeline template is associated with an AI pipeline template management engine that provides a repository and AI pipeline template management of the AI pipeline template; and
storing the AI pipeline template.

16. The media of claim 15, wherein the operations further comprise:
receiving a request from a user interface for the AI pipeline template; and
based on receiving the request, communicating the AI pipeline template.

17. The media of claim 15, wherein the AI pipeline management data comprises one or more of: configuration metadata, operational metadata, and documentation metadata.

18. The media of claim 15, wherein the modular pipeline definition is associated with a first processing category, and the AI pipeline template is associated with a second processing category.

19. The media of claim 15, wherein the AI pipeline templates are associated with the AI pipeline management engine that operates based on a unified pipeline specification comprising a flow logic, processor scripts, and metadata.

20. The media of claim 16, the operations further comprising:
accessing an indication to register a reusable module;
generating reusable module management data for the reusable module; and
based on the reusable module management data, storing the reusable module.
